(19) United States
(12) Patent Application Publication
(10) Pub. No.: US 2026/0053311 A1
(43) Pub. Date: Feb. 26, 2026

(54) HAND VACUUM CLEANER AND AUTO-EMPTY DOCK

(71) Applicant: Origyn LLC, Wayland, MA (US)

(72) Inventors: Jason THORNE, Dover, MA (US); Charles S. BRUNNER, Portsmouth, NH (US); Andre D. BROWN, Holliston, MA (US); Daniel R. SPILLANE, Brookline, MA (US); Gary V. PALLADINO, Roslindale, MA (US)

(73) Assignee: Origyn LLC, Wayland, MA (US)

(21) Appl. No.: 19/304,852

(22) Filed: Aug. 20, 2025

Related U.S. Application Data
(60) Provisional application No. 63/685,467, filed on Aug. 21, 2024.

(51) Int. Cl. A47L 9/14; A47L 5/14; A47L 9/00; A47L 9/12; A47L 9/32; B01D 45/16; B65F 1/06

(52) U.S. Cl. CPC A47L 9/149; A47L 5/14; A47L 9/0063; A47L 9/12; A47L 9/1445; A47L 9/325; B01D 45/16; B65F 1/06

(57) ABSTRACT

A vacuum cleaner that interfaces with a waste bin system is disclosed. includes a waste receptacle, a first air intake coupled to the waste receptacle, a first filter adjacent to the waste receptacle, a motor, a conduit coupled between the motor and the first filter, a second air intake coupled to the motor, and a second filter coupled to an exhaust port of the motor. The motor is configured to change between a first state and a second state. In the first state, the motor is configured to move air through the first air intake into the waste receptable, through the conduit towards the motor, and through the second filter away from the motor. In the second state, the motor is configured to move air through the second air intake towards the motor, through the conduit away from the motor, and through the waste receptacle.

### CROSS-REFERENCE TO RELATED APPLICATIONS

This application claims the benefit of U.S. Provisional Application No. 63/685,467, filed Aug. 21, 2024, the disclosure of which is incorporated by reference herein in its entirety.

### BACKGROUND

Cleaning tools such as vacuum cleaners have been used for decades to aid in cleaning dirt and other debris from floors. Most vacuum cleaners have a built-in motor to facilitate air suction and a waste receptacle to collect dirt and debris. It can be difficult to efficiently remove the debris from the waste receptacle or maximize the available space within the waste receptacle. Accordingly, there exist some drawbacks and other unsolved issues that limit the convenience of vacuum cleaners.

### BRIEF DESCRIPTION OF THE DRAWINGS

Features and advantages of embodiments of the claimed subject matter will become apparent as the following Detailed Description proceeds, and upon reference to the Drawings, in which:

FIGS. 1A and 1B illustrate different views of a handheld vacuum cleaner along with a waste bin system, in accordance with some embodiments of the present disclosure.

FIG. 2 illustrates a view of the interaction between the handheld vacuum cleaner and the waste bin system to empty contents of the waste receptacle of the handheld vacuum cleaner into the waste bin system, in accordance with some embodiments of the present disclosure.

FIG. 3 illustrates various components of the handheld vacuum cleaner including a motor that changes between a first suction state and a second suction state, in accordance with some embodiments of the present disclosure.

FIG. 4 illustrates the handheld vacuum cleaner from FIG. 3 coupled to the waste bin system and shows the flow of air between the handheld vacuum cleaner and the waste bin system, in accordance with some embodiments of the present disclosure.

FIGS. 5A-5D illustrate various other views of the handheld vacuum cleaner, according to some embodiments of the present disclosure.

FIGS. 6A and 6B illustrate the waste bin system interfacing with a docking station, in accordance with some embodiments of the present disclosure.

FIG. 7 illustrates the docking station interfacing with a vacuum cleaner, in accordance with some embodiments of the present disclosure.

FIG. 8 illustrates the handheld vacuum cleaner on the waste bin system and a nozzle attachment stored in the docking station, in accordance with some embodiments of the present disclosure.

FIG. 9 illustrates the removal of a top section of the waste bin system, in accordance with some embodiments of the present disclosure.

FIG. 10 is a flow chart of a method for emptying the waste receptacle of a vacuum cleaner, in accordance with some embodiments of the present disclosure.

FIG. 11 is a flow chart of another method for emptying the waste receptacle of a vacuum cleaner, in accordance with some embodiments of the present disclosure.

Although the following Detailed Description will proceed with reference being made to illustrative embodiments, many alternatives, modifications, and variations thereof will be apparent in light of this disclosure.

### DETAILED DESCRIPTION

As noted above, there are some non-trivial issues with the designs of most vacuum cleaners. Many of the issues pertain to matters of convenience for the user. For example, vacuum cleaners include a waste receptacle for holding the debris picked up by the suction. Waste receptacles only hold a particular volume of dirt and debris before it needs to be emptied. These waste receptacles often have a particular geometry to fit the given vacuum cleaner and may be difficult to empty completely based on their geometry. For example, dirt and other debris may be stuck in areas of the waste receptacle not near the door, or may be stuck against the filter screen in parts of the waste receptacle that are difficult to access. Furthermore, the emptying of the waste receptacle often forms a dust plum that can redeposit the dirt and debris into the environment.

Thus, and in accordance with some embodiments, a vacuum cleaner is described having a motor that can change its air suction path between two states: a first state that sucks air and debris into the waste receptacle and a second state that expels air and debris out of the waste receptacle. In an embodiment, the vacuum cleaner can interface with a waste bin system to expel the dirt and debris from the waste receptacle into a storage chamber of the waste bin system while drawing air from the waste bin system back into the vacuum cleaner. In this way, the motor of the vacuum cleaner can be used in different states to either fill the waste receptacle or empty the waste receptacle. Furthermore, the waste bin system can be a passive system with no motor as the motor from the vacuum cleaner is used to help expel the debris into the storage chamber of the waste bin system.

According to some embodiments, the vacuum cleaner includes a first air intake coupled to the waste receptacle. When the motor is in the first state, air is drawn through the first air intake and into the waste receptacle where dirt and debris is deposited. The air then continues through one or more filters on its way towards the motor and is expelled from the motor through another filter before being vented into the atmosphere around the vacuum cleaner. According to some embodiments, the vacuum cleaner also includes a second air intake. When the motor is in the second state, air is drawn through the second air intake and into the motor. The air is then expelled from the motor and directed through the waste receptacle in order to remove dirt and debris from the waste receptacle through an open end of the waste receptacle (e.g., revealed by an open door). The motor may be coupled to a mount that is rotated between the first state and second state to align a motor inlet and a motor outlet to different pathways within the vacuum cleaner. In some other examples, the motor remains stationary, and a valve system changes the inlet and outlet pathways of the motor between the first state and the second state.

The vacuum cleaner may be configured to interface with a waste bin system to expel the dirt and debris from the waste receptacle into the waste bin system when operating the motor in the second state. According to some embodiments, the air flow circulates between the vacuum cleaner and the waste bin system to expel the dirt and debris from the waste receptacle while also cleaning the outside of the filters (e.g., pre-motor filter and/or waste receptacle filter). The waste bin system includes a chamber for holding the dirt and debris and an air outlet in the chamber where air can flow through the air outlet and back into the second air intake of the vacuum cleaner. The waste bin system may include one or more filter structures or dirt separation structures to clean the air before it passes back through the motor via the second air intake.

According to an embodiment, a vacuum cleaner includes a waste receptacle, a first air intake coupled to the waste receptacle, a first filter adjacent to the waste receptacle, a motor, a conduit coupled between the motor and the first filter, a second air intake coupled to the motor, and a second filter coupled to an exhaust port of the motor. The motor is configured to change between a first state and a second state. In the first state, the motor is configured to move air through the first air intake into the waste receptable, through the conduit towards the motor, and through the second filter away from the motor. In the second state, the motor is configured to move air through the second air intake towards the motor, through the conduit away from the motor, and through the waste receptacle.

According to an embodiment, a waste bin system includes a housing comprising a storage chamber, an inlet into the storage chamber and configured to interface with a waste receptacle of a vacuum cleaner, and an outlet coupled to the storage chamber and configured to interface with an air intake of the vacuum cleaner. In some examples, the waste bin does not include any electrical components. In some examples, the waste bin includes a charging port for the vacuum cleaner but does not include a motor.

According to an embodiment, a method of emptying the waste receptacle of a vacuum cleaner includes pressing the vacuum cleaner against an outer surface of a waste bin system, such that the waste receptacle of the vacuum cleaner is aligned with an inlet into a storage chamber of the waste bin system, and an air intake of the vacuum cleaner is aligned with an outlet of the storage chamber; opening a door on the waste receptacle to allow debris within the waste receptacle to fall into the storage chamber through the inlet; and activating a motor of the vacuum cleaner to expel air from the waste receptacle into the storage chamber to draw air back into the vacuum cleaner through the air intake coupled to the outlet of the storage chamber.

According to another embodiment, a vacuum storage system includes a waste bin system and a docking station. The waste bin system includes a housing having a storage chamber, and an inlet into the storage chamber configured to interface with a waste receptacle of a vacuum cleaner. The docking station includes a bay configured to house a nozzle head of the vacuum cleaner. The waste bin system is detachably coupled to a top of the docking station.

These and other such embodiments will be described in more detail herein.

The description uses the phrases “in an embodiment” or “in embodiments,” which may each refer to one or more of the same or different embodiments. Furthermore, the terms “comprising,” “including,” “having,” and the like, as used with respect to embodiments of the present disclosure, are synonymous. When used to describe a range of dimensions, the phrase “between X and Y” represents a range that includes X and Y.

Spatially relative terms, such as “beneath,” “below,” “lower,” “above,” “upper,” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

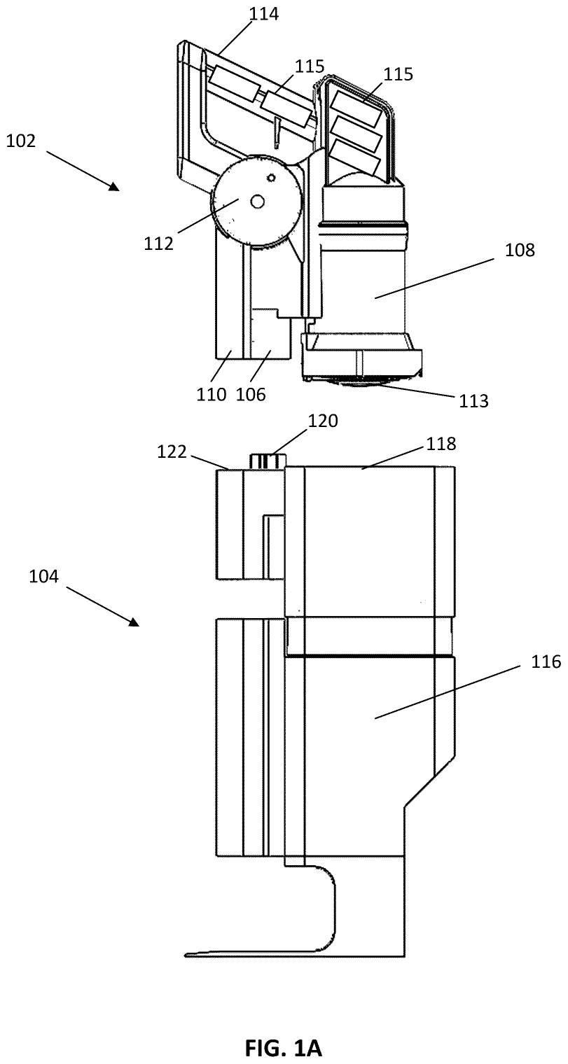

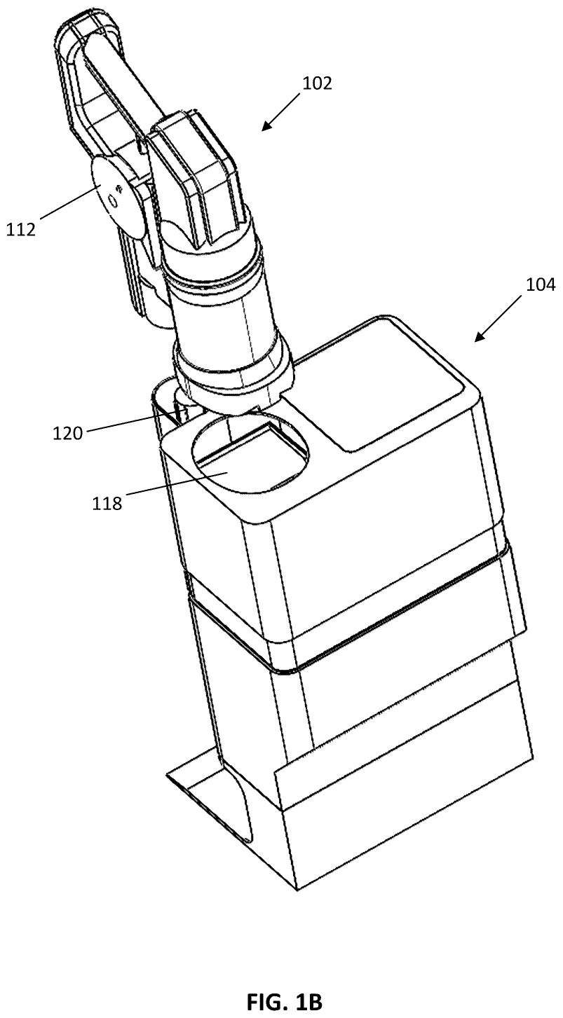

FIG. 1A illustrates a side view and FIG. 1B illustrates an isometric view of a vacuum cleaner 102 and a waste bin system 104, according to an embodiment. Vacuum cleaner 102 has the general shape of a hand vac, however, it should be understood that the embodiments described herein may be used on any type of vacuum cleaner, such as a stick vacuum cleaner, canister vacuum cleaner, or upright vacuum cleaner.

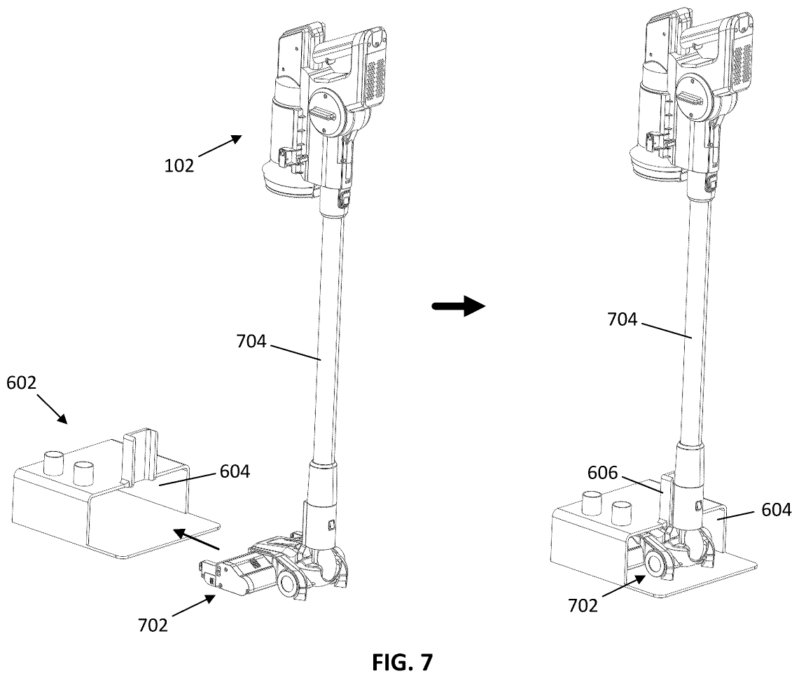

According to some embodiments, vacuum cleaner 102 includes a first air intake 106 that leads into a waste receptacle 108. In some examples, first air intake 106 couples to a nozzle adapter to extend the air intake. The nozzle adapter may include any suitable vacuum nozzle design or cleaning attachment, such as a slot for handheld vacuuming, or a long, extended tube connected to a nozzle head for upright operation (as illustrated, for example, in FIG. 7). In any case, air along with dirt and debris may be drawn through first air intake 106 and into waste receptacle 108. According to some embodiments, vacuum cleaner 102 also includes a second air intake 110, which may be located adjacent to first air intake 106. Second air intake 110 leads directly towards a motor housed within a rotatable mount 112, according to some embodiments.

The motor may be any suitable vacuum motor, such as a brushed or brushless DC motor. According to some embodiments, the motor is configured to operate in a first state or a second state. In an example first state, the motor draws air through first air intake 106 and into waste receptacle 108. The air continues from waste receptacle 108 through any number of filters and back into the motor where it is then expelled from vacuum cleaner 102. In an example second state, the motor draws air through second air intake 110 and expels air from the motor towards waste receptacle 108. A door 113 at a distal end of waste receptacle 108 may be opened for the air and debris to exit from waste receptacle 108. According to some embodiments, first air intake 106 is closed during the operation of the motor in the second state and second air intake 110 is closed during operation of the motor in the first state. According to some embodiments, the motor is coupled to mount 112 which is designed to rotate within vacuum cleaner 102 to change the motor between the first state and the second state, such that the motor's air inlet and air outlet are aligned with different pathways between the first state and the second state. According to some embodiments, a valve system is changed between the first state and the second state to reroute the air pathway between the air inlet and air outlet of the motor.

According to some embodiments, vacuum cleaner 102 includes a grip 114. In the illustrated example, grip 114 has a pistol grip design, although other grip designs may be used as well. One or more batteries 115 may be arranged within grip 114 and/or above grip 114, according to some embodiments. One or more batteries 115 may be any suitable rechargeable energy storage devices, such as rechargeable lithium ion batteries. One or more batteries 115 may be removable and replaceable by a user, or one or more batteries 115 may be integrated within grip 114 such that they are not accessible.

According to some embodiments, waste bin system 104 includes a storage chamber 116 that is larger than waste receptacle 108, and thus capable of holding more dirt and debris before it needs to be emptied. In some examples, a garbage bag is placed within storage chamber 116 to collect the dirt and debris. For example, storage chamber 116 may be appropriately sized to fit at least a 10-liter kitchen bag.

Waste bin system 104 includes an inlet 118 that is designed to receive dirt and debris from waste receptacle 108. Accordingly, the dirt and debris falls or is forced from waste receptacle 108 through inlet 118 and into storage chamber 116. In some examples, vacuum cleaner 102 is pushed down onto the top of waste bin system 104 to align waste receptacle 108 with inlet 118. The action of pushing vacuum cleaner 102 against waste bin system 104 may cause door 113 at the end of waste receptacle 108 to open. Any other actions such as pressing a button, twisting a knob, or actuating a lever may also be used to cause door 113 to open. Inlet 118 may have an indented shape that fits the shape at the end of waste receptacle 108 to facilitate the alignment between them, as generally illustrated in FIG. 1B. In some embodiments, inlet 118 has its own door that is normally closed (e.g., to reduce odor from the contents within storage chamber 116) and is designed to open when vacuum cleaner 102 is engaged with waste bin system 104.

According to some embodiments, waste bin system 104 also includes a structure 120 that is designed to interface with first air intake 106 of vacuum cleaner 102 in order to close off first air intake 106. In an example, structure 120 protrudes outwards and fits within at least a portion of first air intake 106 when vacuum cleaner 102 is placed on waste bin system 104 to empty the contents of waste receptacle 108. Structure 120 may include a polymer material or other compliant material to form a more robust seal at the end of first air intake 106 when first air intake 106 is brought down upon structure 120. According to some embodiments, waste bin system 104 includes an outlet 122 through which air may be drawn from storage chamber 116 and back into vacuum cleaner 102 via second air intake 110. As such, second air intake 110 may be aligned with outlet 122 when vacuum cleaner 102 is placed on waste bin system 104 to empty the contents of waste receptacle 108.

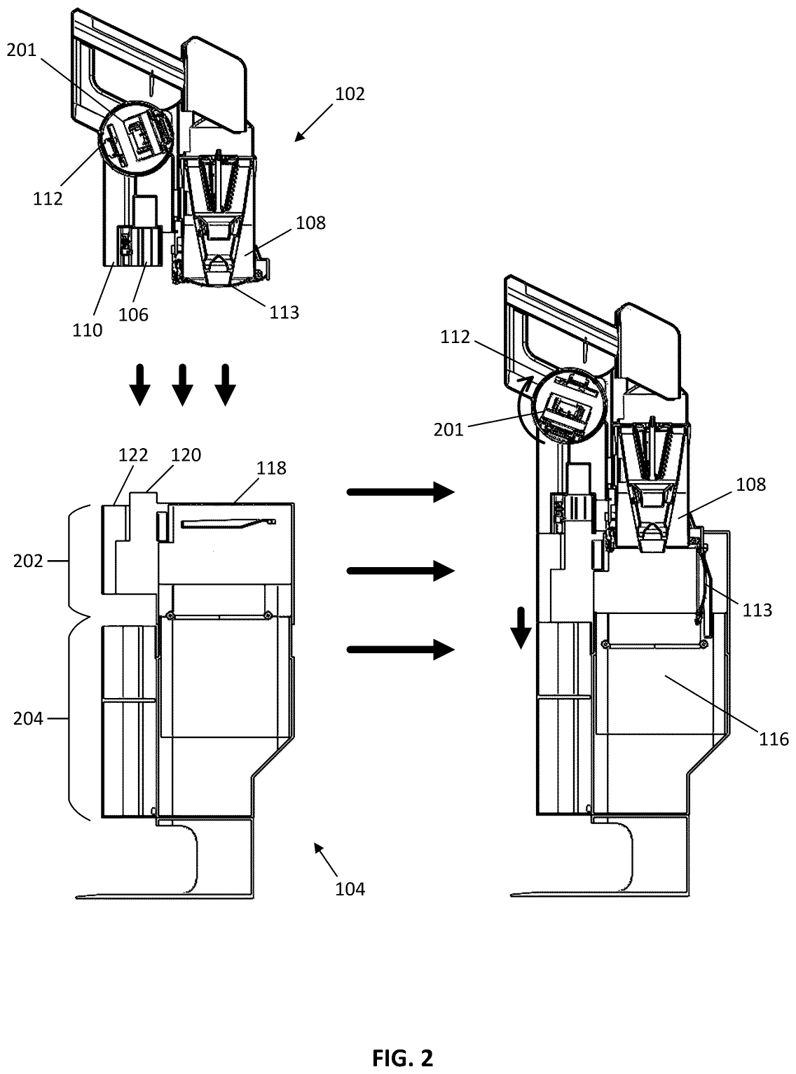

FIG. 2 illustrates how vacuum cleaner 102 may be placed on a top surface of waste bin system 104, according to some embodiments. Vacuum cleaner 102 may be pressed down on a top surface of waste bin system 104 with waste receptacle 108 aligned with inlet 118, first air intake 106 aligned with structure 120, and second air intake 110 aligned with outlet 122. The motor 201 is illustrated within mount 112, such that mount 112 and motor 201 are configured to rotate together between the first state and the second state. Prior to being coupled to waste bin system 104, motor 201 may be in a first state, such as at a particular rotational position. In the first state, vacuum cleaner 102 may be used to draw air and debris up first air intake 106 into waste receptacle 108.

According to some embodiments, waste bin system 104 includes a top portion 202 and a bottom portion 204. Top portion 202 may be configured to move downwards towards bottom portion 204 in response to the pressure of pushing vacuum cleaner 102 down on the top surface of top portion 202. In the illustration on the right, vacuum cleaner 102 has been fully engaged with the top of waste bin system 104, and top portion 202 has been pushed downwards and engaged with bottom portion 204. According to some embodiments, the mechanical engagement between top portion 202 and bottom portion 204 may be sufficient to hold top portion 202 against bottom portion 204 during the emptying of waste receptacle 108 and may be released to allow top portion 202 to slide away from bottom portion 204 back to its starting position.

According to some embodiments, the act of engaging vacuum cleaner 102 with waste bin system 104 also causes door 113 to swing open, thus allowing the contents of waste receptacle 108 to empty into storage chamber 116. A mechanical latch may be engaged when vacuum cleaner 102 is pushed down onto waste bin system 104 to open door 113 via a spring mechanism. In some other examples, a button, lever, or similar element on either waste bin system 104 or vacuum cleaner 102 may be actuated by a user to cause door 113 to swing open. According to some embodiments, the act of engaging vacuum cleaner 102 with waste bin system 104 causes another door over inlet 118 to open, such that the door over inlet 118 and door 113 may be opened together. Similarly, the removal of vacuum cleaner 102 from waste bin system 104 may cause the door over inlet 118 to close (e.g., the door may be spring-loaded to shut on its own) as well as cause door 113 to close via another spring-loaded mechanism or any suitable mechanical latch.

According to some embodiments, the act of engaging vacuum cleaner 102 with waste bin system 104 causes motor 201 to change from the first state to a second state via rotation of mount 112. In an example, mount 112 rotates (as indicated by the arrow on the right-hand illustration) to also rotate motor 201 from the first state to a second state. In the second state, motor 201 may be used to draw air through second air intake 110 and expel air through waste receptacle 108 and into storage chamber 116. Thus, a closed recirculating air path may be formed between vacuum cleaner 102 and waste bin system 104, using motor 201 of vacuum cleaner 102 to move the air. In some examples, disengaging vacuum cleaner 102 from waste bin system 104 can cause door 113 to shut against waste receptacle 108, and/or can cause motor 201 to change from the second state back to the first state. In some other examples, a button, lever, or similar element on either waste bin system 104 or vacuum cleaner 102 may be actuated by a user to cause motor 201 to change between the first state and the second state.

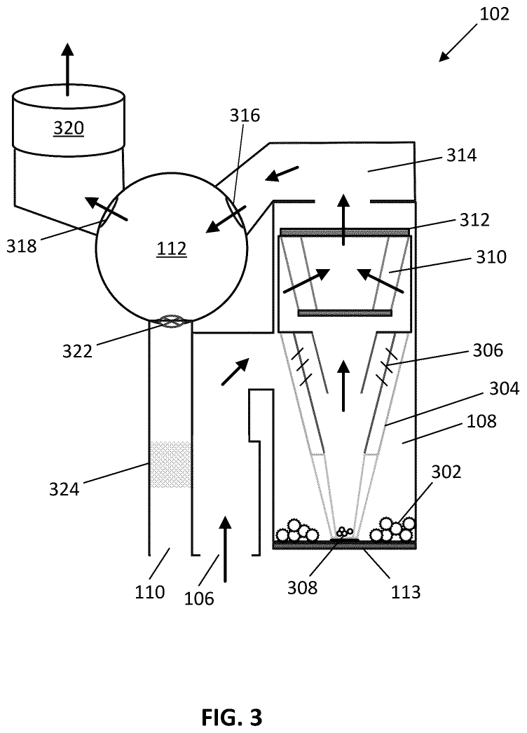

FIG. 3 shows the various components within vacuum cleaner 102, according to some embodiments. When mount 112 is in a first illustrated position, the motor operates in its first state, and the air follows the path shown by the arrows through vacuum cleaner 102. As noted above, air along with dirt and debris may be drawn through first air intake 106 into waste receptacle 108. Larger dirt/debris 302 settles within waste receptacle 108 (And against door 113 when vacuum cleaner 102 is held upside down, as illustrated). According to some embodiments, waste receptacle 108 includes a mesh or screen 304 through which air can pass, but larger dirt/debris 302 cannot. The air passes first into waste receptacle 108 and through screen 304 (or generally through any openings) to a region within screen 304 where it continues to be drawn upwards towards a separator 306. According to some embodiments, dirt/debris 302 represents any debris or particles larger than the size of the holes of screen 304. Any particles that pass through screen 304 (e.g., fine debris 308) may be separated from the airstream and be collected at a bottom portion of screen 304 (e.g., adjacent to door 113). According to some embodiments, separator 306 includes one or more cyclones to separate fine debris 308 from the airstream as it continues upwards towards first filter 310. In some embodiments, screen 304 has a conical shape within waste receptacle 108, as illustrated.

According to some embodiments, air may be drawn from waste receptacle 108 through first filter 310. First filter 310 may be supported by a filter frame 312. According to some embodiments, first filter 310 may include activated carbon in powered, granular, or honeycomb form, or foam-based materials. First filter 310 may have a donut or annular shape around the circumference of filter frame 312. It should be understood that vacuum cleaner 102 may include separator 306 but not first filter 310, or vacuum cleaner 102 may include first filter 310 but not separator 306.

According to some embodiments, air passes through first filter 310 and through a conduit 314 towards a first port 316 of mount 112 when the motor operates in the first state. The air is then expelled from the motor out of a second port 318 of mount 112 where it passes through a second filter 320 before being vented into the atmosphere away from vacuum cleaner 102. Second filter 320 may be a high efficiency particulate air (HEPA) filter. Note that, in the first state, a wall or closed port 322 is aligned over second air intake 110, such that no air passes through closed port 322 into or out of second air intake 110. According to some embodiments, mount 112 is designed to rotate into a second state such that closed port 322 moves to block the access to second filter 320, first port 316 aligns with second air intake 110 and second port 318 aligns with conduit 314. In other examples, any number of valves may be actuated to achieve the same outcome. According to some embodiments, second air intake 110 includes a mesh or screen 324 to filter any particles from being drawn into the motor when the motor operates in the second state.

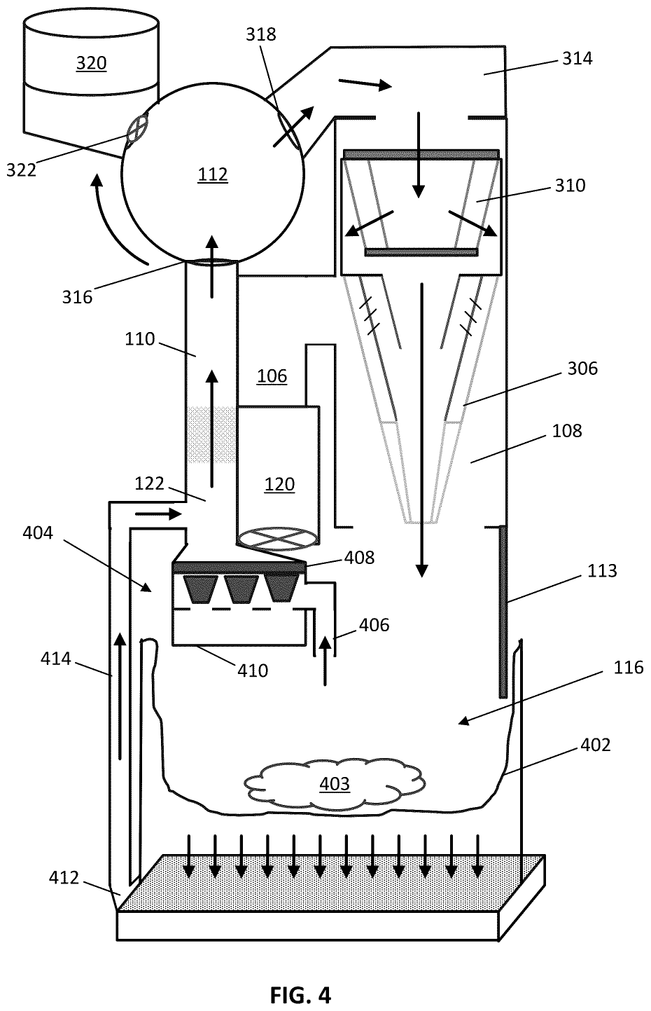

FIG. 4 illustrates the entire coupled system of vacuum cleaner 102 with waste bin system 104, according to some embodiments. As noted above, a bag 402 may be placed within storage chamber 116 to collect debris 403 that is emptied from waste receptacle 108. Bag 402 may be any standard garbage bag, and in some examples, is a 10-liter (or larger) garbage bag. Bag 402 may be removed and replaced as it becomes full. As discussed above, the engagement of vacuum cleaner 102 with waste bin system 104 causes door 113 to swing open and allow both dirt/debris 302 and fine debris 308 to fall or be blown into bag 402 within storage chamber 116. Furthermore, engagement of vacuum cleaner 102 with waste bin system 104 may also cause mount 112 (along with the motor) to rotate from its first state to its second state where air can now be drawn through second air intake 110 and expelled through conduit 314. In another example, engagement of vacuum cleaner 102 with waste bin system 104 causes first air intake 106 to be blocked by structure 120.

According to some embodiments, waste bin system 104 includes a debris filtration unit 404. Debris filtration unit 404 may be housed within storage chamber 116. According to some embodiments, debris filtration unit includes a chamber intake 406 that draws air from storage chamber 116 and through a debris separator 408. In some examples, debris separator 408 includes one or more cyclones or other similar passive filtration structures to remove dirt and debris from the air. The removed dirt and debris may be collected within a debris collector 410 adjacent to debris separator 408. In some examples, both debris separator 408 and debris collector 410 are housed together within debris filtration unit 404. Air that passes through debris separator 408 may exit waste bin system 104 via outlet 122 and into second air intake 110.

According to some embodiments, a closed loop air circulation may be formed between vacuum cleaner 102 and waste bin system 104 when the motor operates in the second state. As illustrated by the arrows, air is expelled from the motor (within mount 112) through conduit 314 and through first filter 310. Since air flows in the reverse direction through first filter 310, debris and/or dirt stuck to first filter 310 may be cleaned off of first filter 310. The air continues through waste receptacle 108 where it may assist in clearing waste receptacle 108 of any remaining dirt or debris. The air flows into storage chamber 116 where debris 403 is collected within bag 402. The air is then returned towards the motor by entering into chamber intake 406 and passing through debris separator 408 before exiting waste bin system 104 through outlet 122 and into second air intake 110. The airflow is created using the motor of vacuum cleaner 102, such that waste bin system 104 can be an entirely passive system. Accordingly, waste bin system 104 may have no electronic components and may have no moving parts. In some embodiments, waste bin system 104 includes a charging port that connects to vacuum cleaner 102 to charge vacuum cleaner 102 when it is placed on waste bin system 104. Such an embodiment can also include a mains connector for plugging into a household outlet.

The suction of air through chamber intake 406 may cause bag 402 to rise within storage chamber 116 as it is pulled upwards. To prevent this from happening, and in accordance with an embodiment, storage chamber 116 includes a second outlet 412 connected to a bottom portion of storage chamber 116. Second outlet 412 may be coupled to a bottom surface of storage chamber 116 or a sidewall of storage chamber 116. A second chamber intake 414 may be coupled to second outlet 412 to provide a pathway for air to return to or return near outlet 122. In the illustrated example, second chamber intake 414 is coupled between second outlet 412 and outlet 122 downstream of debris filtration unit 404. In some examples, second chamber intake 414 is coupled between second outlet 412 and debris filtration unit 404. According to some embodiments, the suction of air through second air intake 110 also draws air up from second chamber intake 414 to provide negative pressure beneath bag 402 within storage chamber 116 (as illustrated by the arrows), thus preventing bag 402 from being pulled upwards. Second chamber intake 414 may run along the outside or inside sidewall of storage chamber 116. Note that little or no air need pass through second outlet 412 but that the reduction in pressure in the second outlet can be adequate to retain bag 402 in its lower, expanded position.

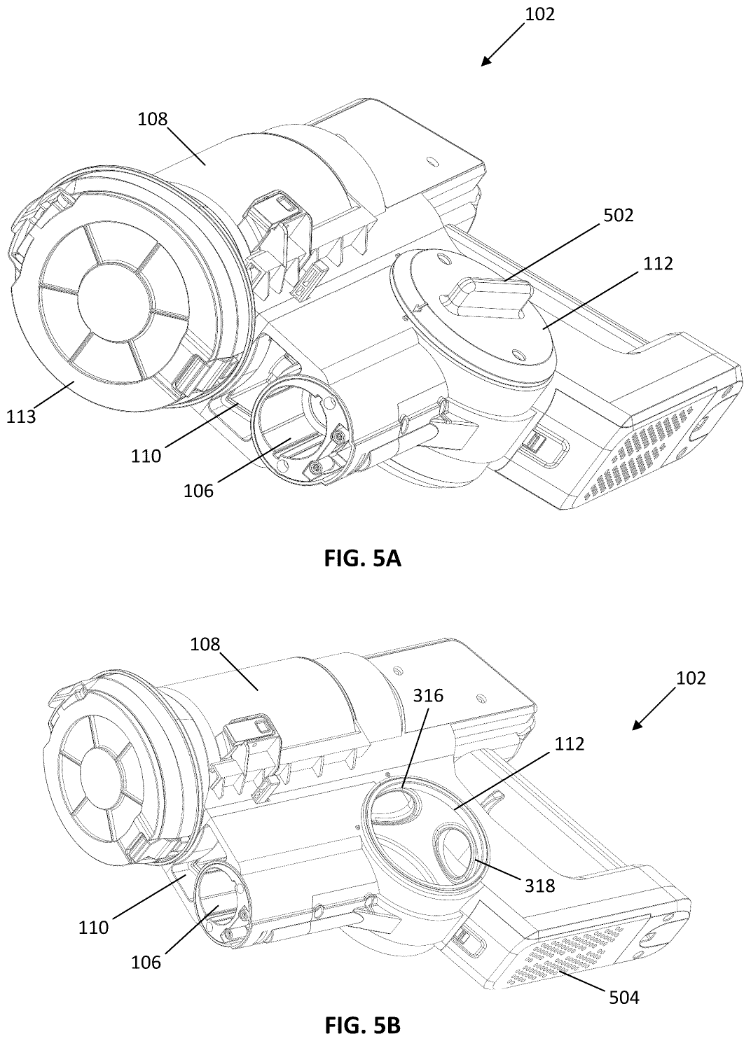

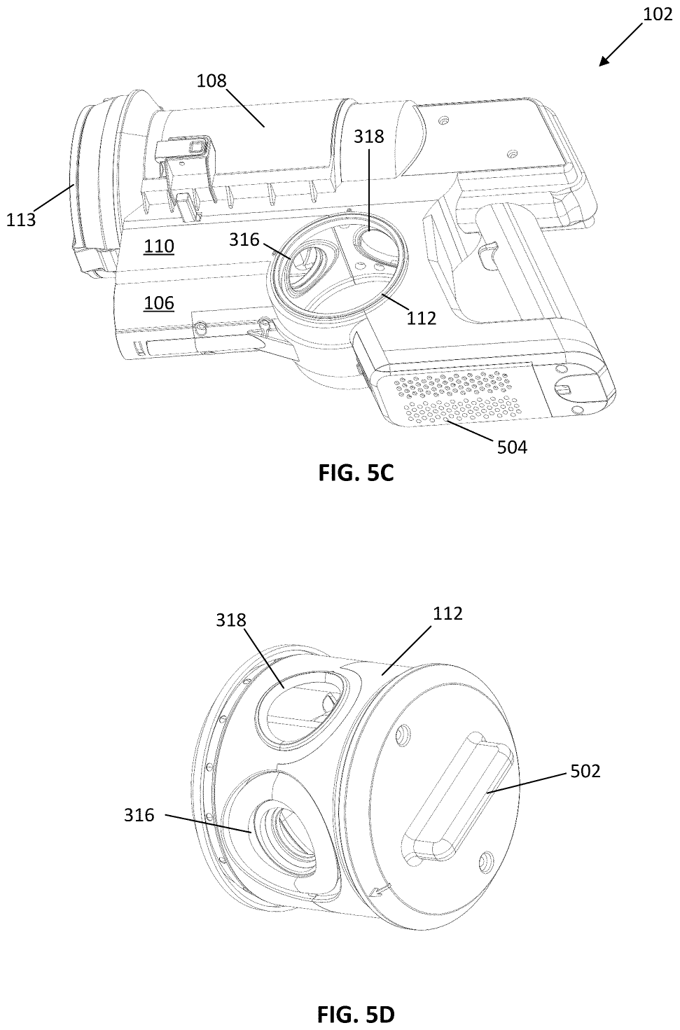

FIGS. 5A-5C illustrate various views of vacuum cleaner 102, according to some embodiments. As discussed above, vacuum cleaner 102 may be a hand vacuum with one or more attachments that can be coupled to first air intake 106 to extend the intake and/or provide other cleaning features. According to some embodiments, mount 112 may include an interface structure 502 as illustrated in FIG. 5A that allows a user to manually rotate mount 112 between the aforementioned first and second states. Accordingly, the user may manually change a rotation direction of the motor coupled within mount 112 to affect the airflow direction through vacuum cleaner 102. In this way, a user could decide to switch the operation of the motor to the second state, open door 113, and blow the dirt and debris out of waste receptacle 108 without interfacing with waste bin system 104. Interface structure 502 may have the form of a twist knob, a sliding button, or any other suitable mechanism to cause rotation of mount 112.

FIG. 5B illustrates mount 112 in the first state, and FIG. 5C illustrates mount 112 in the second state with the motor removed such that first port 316 and second port 318 of mount 112 can be more easily seen, according to some embodiments. FIG. 5D illustrates mount 112 removed from the rest of vacuum cleaner 102. The rotation of mount 112 causes a corresponding rotation to the position of first port 316 and second port 318 to align with different pathways within vacuum cleaner 102. In the first state, air is pulled through first air intake 106 and (after passing through waste receptacle 108) through first port 316 and exits through second port 318 where it can ultimately exit through vent 504. The opening into second air intake 110 is blocked by a wall or closed port of mount 112. In the second state, air is pulled through second air intake 110 and through first port 316 and exits through second port 318 where it blows through waste receptacle 108 and out of the entrance into waste receptacle 108 (covered by door 113 in FIG. 5C). The wall or closed port of mount 112 closes off the pathway towards vent 504 when in the second state, according to some embodiments. As noted above, the motor may rotate along with mount 112 between the first state and the second state. However, in some embodiments, the motor remains stationary while mount 112 rotates to change the relative positions of first port 316 and second port 318 to correspondingly change the direction of airflow into and out from the motor.

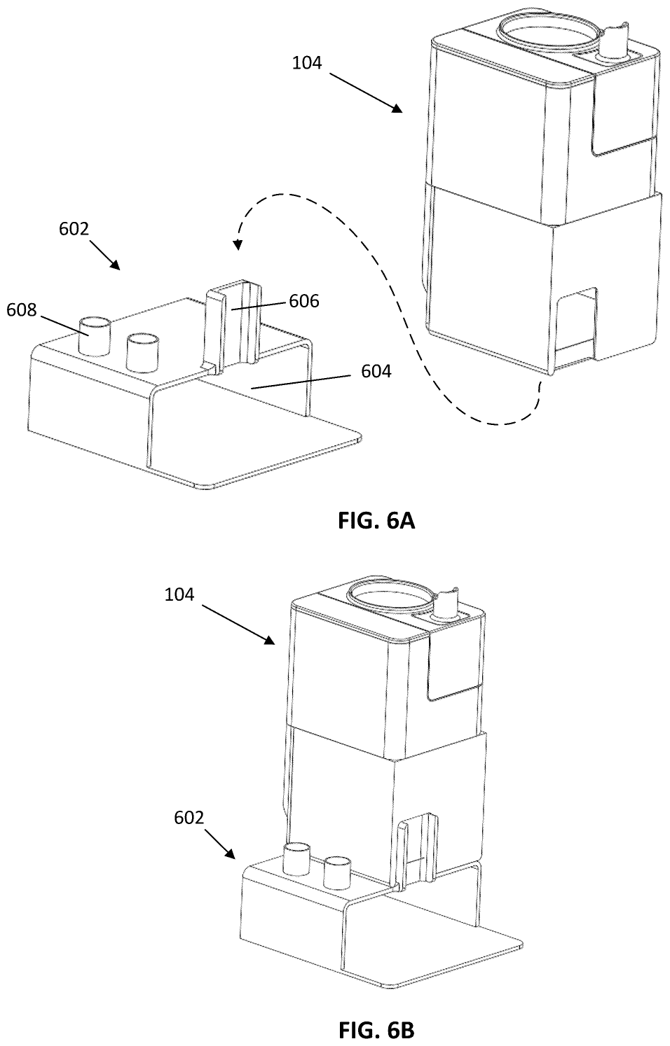

FIGS. 6A and 6B illustrate how waste bin system 104 can be coupled to a docking station 602 to provide further user-friendly features. For example, docking station 602 may include a bay 604 for storing the nozzle head of a vacuum when it is not in use. The vacuum nozzle head may include a suction tube extending upwards from the nozzle head, and the suction head may rest against structure 606 or by clipped into structure 606. In some examples, docking station 602 may include any number of raised features 608 that can be used to store various vacuum attachments. For example, nozzle attachments may be slid over raised features 608 when not in use. FIG. 6B illustrates one way in which waste bin system 104 can be placed onto docking station 602. In some examples, docking station 602 includes a corded plug for connecting to a wall outlet to provide power for charging a vacuum cleaner that is brought into bay 604 or to charge a hand vacuum cleaner that is placed onto waste bin system 104.

It should be understood that waste bin system 104 may be fully functional even when not connected to docking station 602. For example, waste bin system 104 does not need to be coupled to docking station 602 to interface with a handheld vacuum cleaner to empty the contents of the vacuum cleaner as discussed with reference to FIG. 4.

FIG. 7 illustrates one example of vacuum cleaner 102 using a nozzle head 702 and a suction tube 704 extending between vacuum cleaner 102 and nozzle head 702. Accordingly, nozzle head 702 and suction tube 704 may be a single attachment that connects to first air intake 106 of vacuum cleaner 102. According to some embodiments, the vacuum cleaner 102 may be pushed forward into docking station 602 such that nozzle head 702 docks into bay 604 as shown in the image on the right. Thus, bay 604 may be appropriately sized to fit nozzle head 702. Bay 604 may include an opening that substantially stretches along an entire side of docking station 602.

In some examples, nozzle head 702 may include one or more conductive terminals that contact corresponding conductive terminals within bay 604 to provide a current path between docking station 602 and one or more batteries within vacuum cleaner 102. Accordingly, the batteries may be charged when nozzle head 702 is docked within bay 604.

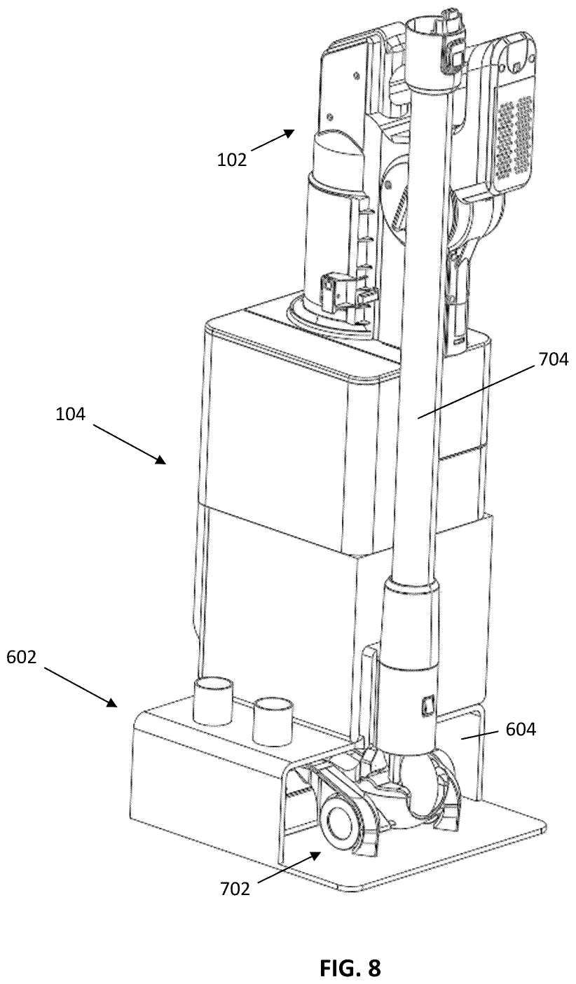

FIG. 8 illustrates an example where waste bin system 104 has been placed on docking station 602 and vacuum cleaner 102 has been detached from suction tube 704 to be coupled to the top of waste bin system 104. According to some embodiments, one or more conductive terminals on the bottom of waste bin system 104 contact corresponding conductive terminals on docking station 602 to provide a current path between docking station 602 and waste bin system 104. Similarly, one or more conductive terminals on the top of waste bin system 104 may align with and contact corresponding one or more conductive terminals on vacuum cleaner 102 when vacuum cleaner 102 is engaged with waste bin system 104. Accordingly, the batteries within vacuum cleaner 102 may be charged when vacuum cleaner 102 is engaged with waste bin system 104.

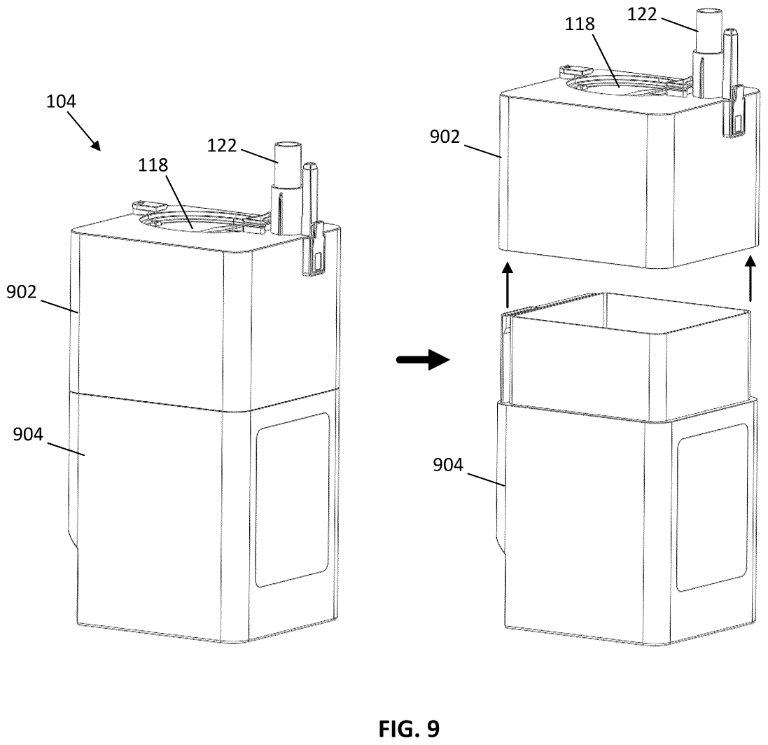

FIG. 9 illustrates another example of waste bin system 104 having a top section 902 and a bottom section 904. According to some embodiments, top section 902 houses any filtration components, such as debris filtration unit 404 described with reference to FIG. 4. Bottom section 904 may include a removable bag for holding the debris and dirt, such as bag 402 from FIG. 4.

According to some embodiments, top section 902 is designed to be lifted up and off of bottom section 904 to provide access into bottom section 904. In this way, a full bag can be removed from bottom section 904 and replaced with a new bag before replacing top section 902 back over bottom section 904. In other examples, top section 902 may rotate open about a hinge along the side of waste bin system 104 to provide access into bottom section 904.

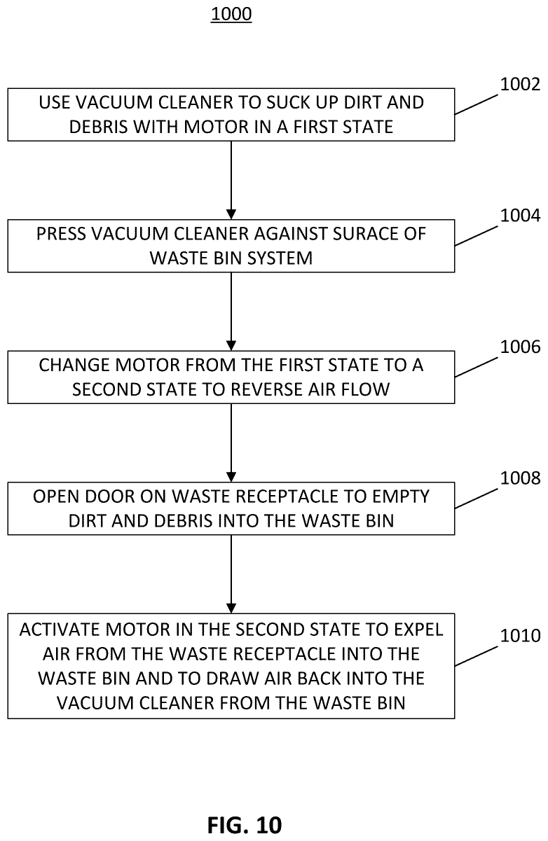

FIG. 10 is a flow chart of a method 1000 for emptying the contents of a waste receptacle in a vacuum cleaner, according to an embodiment. Various operations of method 1000 may be illustrated in any of the aforementioned figures of the application. However, the correlation of the various operations of method 1000 to the specific components illustrated in the aforementioned figures is not intended to imply any structural and/or use limitations. Rather, the aforementioned figures provide one example embodiment of method 1000. Other operations may be performed before, during, or after any of the operations of method 1000. Some of the operations of method 1000 may be performed in a different order than the illustrated order.

Method 1000 beings with operation 1002 where a vacuum cleaner is used to suck up dirt and debris with a motor operating in a first state. According to some embodiments, the vacuum cleaner may be a handheld vacuum with a relatively small waste receptacle, which can be conveniently emptied into a larger waste bin system. The motor may operate in a first state when it is in a particular rotational position within the vacuum cleaner. According to some embodiments, the motor operates in the first state by drawing dirt and debris through a first air intake into the waste receptacle and continuing to draw air through a filter downstream of the waste receptacle before expelling the air through a second filter.

Method 1000 continues with operation 1004 where the vacuum cleaner is pressed against a surface of the waste bin system. In some embodiments, the vacuum cleaner is pressed downwards onto a top surface of the waste bin system to align the waste receptacle of the vacuum cleaner with an inlet of the waste bin system. Other ports may be aligned as well. For example, the first air intake of the vacuum cleaner may be aligned with a structure that blocks entry into the first air intake. Furthermore, a second air intake of the vacuum cleaner may be aligned with an outlet of the waste bin system to facilitate circulating air between the vacuum cleaner and the waste bin system. Pressing the vacuum cleaner against the waste bin system may cause at least a portion of the waste bin system to move or slide from the exerted pressure.

Method 1000 continues with operation 1006 where the motor is changed from the first state to a second state to effectively reverse the airflow through at least the waste receptacle. As discussed above, the motor may be coupled to a mount that is rotated such that different ports of the mount are aligned with different passageways within the vacuum cleaner. According to some embodiments, when changed to the second state, the motor is designed to draw air from the second air intake and expel air out through the waste receptacle (the first air intake is not used). In some embodiments, one or more valves are actuated to change the airpath connected to the inlet and outlet of the motor. In some embodiments, the rotation of the motor/mount (or changing of valves) to cause air to flow in a direction opposite to that of normal vacuum operation is caused by pressing the vacuum cleaner against the waste bin system. Accordingly, a mechanical connection may be provided between the vacuum cleaner and waste bin system to cause the motor/mount to rotate in response to pressing the vacuum cleaner on to the waste bin system. In some other embodiments, rotation of the motor/mount between the first state and the second state may be manually performed by a user.

Method 1000 continues with operation 1008 where a door on the waste receptacle is opened. According to some embodiments, the door of the waste receptacle may open in response to pushing the vacuum cleaner against the waste bin system. Accordingly, a mechanical latch or other mechanism may be activated when pressing the vacuum cleaner against the waste bin system that causes the door to swing open. Once the door has been opened, the contents of the waste receptacle can be emptied into the storage chamber of the waste bin system. In some examples, the waste receptacle includes an area for coarse debris and a separate compartment for fine debris. Both the coarse and fine debris may be expelled together from the waste receptacle into the storage chamber. Note that, in some embodiments, operation 1008 and operation 1006 occur simultaneously in response to pushing the vacuum cleaner against the waste bin system.

Method 1000 continues with operation 1010 where the motor is activated in the second state to expel air from the waste receptacle into the storage chamber of the waste bin system and to draw air back into the vacuum cleaner from the waste bin system. According to some embodiments, a closed loop air circulation is formed between the vacuum cleaner and the waste bin system when the motor operates in the second state. For example, air is expelled from the motor through a conduit and through a filter of the vacuum cleaner in the reverse direction, thus dislodging debris and/or dirt stuck to the filter. The air continues through the waste receptacle where it may assist in clearing the waste receptacle of any remaining dirt or debris. The air flows into the storage chamber of the waste bin system where the debris can be collected within a bag. The air is then returned by entering into a chamber intake within the storage chamber and passing through a debris separator before exiting the waste bin system through an outlet and into a second air intake of the vacuum cleaner. The airflow is created using the motor of the vacuum cleaner, and as such no motors are required in the waste bin system.

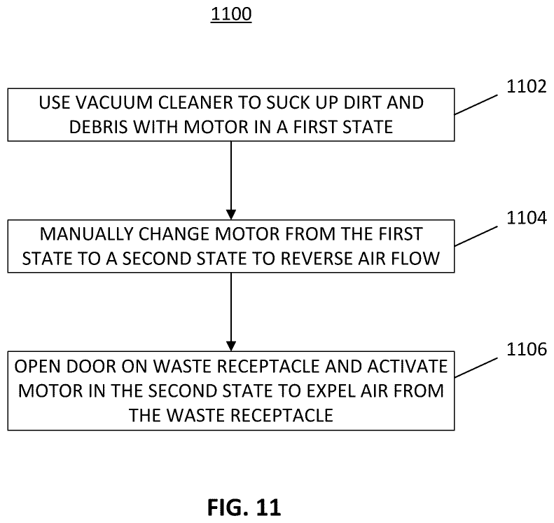

FIG. 11 is a flow chart of another method 1100 for emptying the contents of a waste receptacle in a vacuum cleaner, according to an embodiment. Various operations of method 1100 may be illustrated in any of the aforementioned figures of the application. However, the correlation of the various operations of method 1100 to the specific components illustrated in the aforementioned figures is not intended to imply any structural and/or use limitations. Rather, the aforementioned figures provide one example embodiment of method 1100. Other operations may be performed before, during, or after any of the operations of method 1100. Some of the operations of method 1100 may be performed in a different order than the illustrated order.

Method 1100 beings with operation 1102 where a vacuum cleaner is used to suck up dirt and debris with a motor operating in a first state. The motor may operate in a first state when it is in a particular rotational position within the vacuum cleaner. According to some embodiments, the motor operates in the first state by drawing dirt and debris through a first air intake into the waste receptacle and continuing to draw air through a filter downstream of the waste receptacle before expelling the air through a second filter.

Method 1100 continues with operation 1104 where the motor is manually changed from the first state to a second state to effectively reverse the airflow through at least the waste receptacle. As discussed above, the motor may be coupled to a mount that can include an interface structure that can be twisted, pushed, or pulled by a user to cause a rotation of the mount. The rotating mount may correspondingly rotate the motor to change the direction that air is drawn and expelled through the vacuum cleaner. According to some embodiments, when changed to the second state, the motor is designed to draw air from the second air intake and expel air out through the waste receptacle (the first air intake is not used). In some embodiments, one or more valves are actuated to change the airpath connected to the inlet and outlet of the motor. This manual change of the motor from the first state to the second state can be performed by a user at any time on the vacuum cleaner.

Method 1100 continues with operation 1106 where the door to the waste receptacle is opened and the motor is activated in the second state to expel air from the waste receptacle. According to some embodiments, air is expelled from the motor through a conduit and through a filter of the vacuum cleaner in the reverse direction, thus dislodging debris and/or dirt stuck to the filter. The air continues through the waste receptacle where it may assist in clearing the waste receptacle of any remaining dirt or debris. The air is blown out of the open end of the waste receptacle (through the open door) along with any dirt or debris within the waste receptacle.

Numerous specific details have been set forth herein to provide a thorough understanding of the embodiments. It will be understood in light of this disclosure, however, that the embodiments may be practiced without these specific details. In other instances, well known operations and components have not been described in detail so as not to obscure the embodiments. It can be appreciated that the specific structural and functional details disclosed herein may be representative and do not necessarily limit the scope of the embodiments. In addition, although the subject matter has been described in language specific to structural features and/or methodological acts, it is to be understood that the subject matter defined in the appended claims is not necessarily limited to the specific features or acts described herein. Rather, the specific features and acts described herein are disclosed as example forms of implementing the claims.

1. A vacuum cleaner, comprising:
a waste receptacle;
a first air intake coupled to the waste receptacle;
a motor;
a conduit coupled between the motor and the waste receptacle; and
a second air intake;
wherein the motor is configured to change between a first state and a second state,
wherein, in the first state, the motor is configured to move air, in order, through the first air intake into the waste receptable, and through the conduit towards the motor, and
wherein, in the second state, the motor is configured to move air, in order, through the second air intake towards the motor, through the conduit away from the motor, and through the waste receptacle.

2. The vacuum cleaner of claim 1, further comprising a pistol grip.

3. (canceled)

4. The vacuum cleaner of claim 1, wherein the waste receptacle comprises a door at a distal end of the waste receptacle.

5. The vacuum cleaner of claim 1, wherein a passage between the second air intake and the motor is closed when the motor is in the first state.

6. The vacuum cleaner of claim 1, wherein the second air intake includes a mesh or screen across an interior of the second air intake.

7-11. (canceled)

12. The vacuum cleaner of claim 1, wherein in the first state, the motor is configured to move air, in order, through the first air intake into the waste receptable, through the conduit towards the motor, and through a filter before exiting from the vacuum cleaner.

13. The vacuum cleaner of claim 12, wherein the motor is coupled to a mount having a first port and a second port, wherein the first port is arranged to face the conduit and the second port is arranged to face a passageway leading to the filter when the motor is in the first state, and the first port is arranged to face the second air intake and the second port is arranged to face the conduit when the motor is in the second state.

14. The vacuum cleaner of claim 13, wherein the motor and mount are configured to rotate between the first state and the second state.

15. (canceled)

16. A waste bin system, comprising:
a housing comprising a storage chamber;
an inlet into the storage chamber configured to interface with a waste receptacle of a vacuum cleaner; and
an outlet coupled to the storage chamber and configured to interface with an air intake of the vacuum cleaner.

17. The waste bin system of claim 16, wherein the storage chamber is sized to fit a household garbage bag having a volume of at least 10 liters.

18. (canceled)

19. The waste bin system of claim 16, further comprising a chamber intake within the storage chamber, such that air can move into the storage chamber via the inlet and from the storage chamber into the chamber intake.

20. The waste bin system of claim 19, further comprising a debris separator coupled to the chamber intake within the storage chamber.

21. The waste bin system of claim 20, further comprising a debris collector configured to collect debris separated from the air by the debris separator.

22. (canceled)

23. (canceled)

24. The waste bin system of claim 16, wherein the outlet is a first outlet and the waste bin system comprises a second outlet coupled to a sidewall or bottom of the storage chamber.

25. The waste bin system of claim 24, wherein the air intake is a first air intake and the second outlet is coupled to a second air intake.

26. (canceled)

27. (canceled)

28. The waste bin system of claim 16, wherein the waste bin does not include any electrical components.

29-35. (canceled)

36. A vacuum storage system, comprising:
a waste bin system comprising
a housing having a storage chamber, and
an inlet into the storage chamber configured to interface with a waste receptacle of a vacuum cleaner; and
a docking station comprising a bay configured to house a nozzle head of the vacuum cleaner,
wherein the waste bin system is detachably coupled to a top of the docking station.

37. (canceled)

38. The vacuum storage system of claim 36, wherein the bay comprises one or more first conductive terminals configured to contact corresponding one or more second conductive terminals on the nozzle head of the vacuum cleaner when the nozzle head is stored in the bay.

39. The vacuum storage system of claim 36, wherein the docking station further comprises a structure protruding from an edge of the docking station above the bay, the structure being configured to interface with a suction tube extending from the nozzle head of the vacuum cleaner.

40. The vacuum storage system of claim 36, wherein the housing comprises a top section and a bottom section, wherein the top section is removable from the bottom section.

41. (canceled)
